(19) United States
(12) Patent Application Publication
(10) Pub. No.: US 2004/0225569 A1
(43) Pub. Date: Nov. 11, 2004

(54) Method and system for creating a multi-tiered, e-commerce extranet for a community of businesses

(76) Inventor: Renee Bunnell, New York, NY (US)

Correspondence Address: MORGAN & FINNEGAN, L.L.P., 3 WORLD FINANCIAL CENTER, NEW YORK, NY, 10281-2101, US

(21) Appl. No.: 10/239,672

(22) PCT Filed: Mar. 28, 2001
(86) PCT No.: PCT/US01/09849

Related U.S. Application Data
(60) Provisional application No. 60/192,979, filed on Mar. 28, 2000.

(51) Int. Cl. G06F 17/60

(52) U.S. Cl. 705/26; 705/1

(57) ABSTRACT

The present invention is an online marketplace where a founder site (402) acts as a hub for all electronic commerce conducted by the marketplace participants. In particular, the founder site (402) accepts customer orders (406), payment (414) and allocates funds to the child site responsible for generating sale minus a commission (423).

### CROSS-REFERENCE TO RELATED APPLICATIONS

The present application claims priority under 35 U.S.C. §119(e)(1) to U.S. Provisional Patent Application Ser. No. 60/192,979 entitled “METHOD AND SYSTEM FOR CREATING A MULTI-TIERED E-COMMERCE EXTRANET FOR A COMMUNITY OF BUSINESSES” filed in the name of Renee Bunnell on Mar. 28, 2000, the entirety of which is hereby incorporated by reference.

### FIELD OF THE INVENTION

This invention relates generally to consumer-to-business and business-to-business transactions performed over a computer network, and relates more particularly to a method and system for building multi-tiered commerce extranets for a community of businesses that share a common set of goals and values.

### BACKGROUND OF THE INVENTION

In today's economy, a great number of private, smaller, specialty businesses are increasingly replaced by the mass homogenization of the marketplace. National chains and large department stores are aggressively securing their stronghold in today's business market while small businesses which promote authentic and real experiences are struggling to compete. For example, local bookstore cafes and hip boutiques are being replaced by national, often impersonal, chains and franchises.

While the Internet's significant growth offers numerous opportunities for advertisement and commerce, smaller specialty businesses have not, for several reasons, taken fill advantage of online marketing and services.

First, the financial commitment involved in creating and maintaining a website is a hardship for many small businesses due to prohibitive startup costs. A basic electronic catalog accommodating off-line transactions may cost between $10,000 to $100,000 to design. A transactional website, on the other hand, may cost as much as $3,000,000 to launch and operate for one year, while initiating and maintaining a content-only website may cost about $1,300,000 just in the first year.

Second, in addition to the lack of capital, small businesses also need to commit time and effort to producing an opportune and efficient Internet service. These factors deter many small businesses from creating Internet websites. Larger companies are better equipped with vast resources for creating these websites because they typically have the manual labor and financial capability required to complete this task in a timely manner. Alternatively, large businesses are more readily able to outsource such work with greater ease.

Third, existing technology does not particularly address the needs of small businesses. Since current technology produces individual sites which do not collect the cross-pollination of information provided by different individual businesses, current online services do not enable business communities to aggregate information, experiences, services or products which would appeal to interested consumers. Thus, the Internet continues to mainstream and standardize consumers' online shopping experiences with larger enterprises at the expense of smaller, specialty businesses which may offer more real and authentic shopping experiences.

Accordingly, there is a need to address the shortcomings of existing technologies.

### SUMMARY OF THE INVENTION

The present invention, in various embodiments, allows for the creation of an online business community which include a group of businesses, where such a community provides a cost-effective means for the promotion of products and services of individual members while further allowing smaller-sized businesses to expand their online presence at a rate commensurate with their growth and financial capabilities.

The present invention, in certain embodiments, provides a method and system for establishing an online, multi-tiered, business community. In accordance with this embodiment, a first tier is implemented for allowing a first provider to post first content on a first network site accessible from a central portal. A second tier, lower than the first tier, is implemented for allowing at least one second provider to post second content on a second network site accessible from the central portal, wherein the second providers each forms a distinct community branch and both the second providers and the second content are subject to approval by the first provider.

In a further embodiment, the present invention provides a method and system for operating a multi-tiered, online, business community wherein a first provider provides first content in a founder tier from a first network site. The first provider then transmits an invitation to a second provider to join a second tier, lower than the founder tier. After receiving an acceptance of the invitation from the second provider, the first provider establishes a second network site for the second provider and receives an indication of second content to be posted on one of the first network site and the second network site. The first provider may then approve or disapprove the second content.

In another embodiment, the present invention provides a method and system for operating a multi-tiered, online, business community wherein a first provider provides first content in a founder tier from a first network site. A second provider then receives an invitation from the first provider to join a second tier, lower than the founder tier, the second tier comprising a community branch. The second provider transmits an acceptance of the invitation to the first provider and receives an assignment of a second network site from the first provider. The second provider then transmits an indication of second content to be posted on one of the first network site and the second network site, wherein the second content is transmitted for approval by the first provider.

In still another embodiment, the present invention provides a method for operating a multi-tiered, online, business community wherein a first provider provides first content in a founder tier from a first network site and a second provider in a second tier, lower than the founder tier, provides second content from a second network site. The second tier forms a separate community branch. A third provider receives an invitation from the second provider to join a subsequent tier, lower than the second tier, within the community branch. The third provider transmits an acceptance of the invitation to the second provider and receives an assignment of a third network site from the second provider. The third provider then transmits an indication of third content to be posted on at least one of the first network site, the second network site and the third network site, wherein the indication of third content is transmitted for approval by at least one of the first provider and the second provider.

In a further embodiment, the present invention provides a method, performed by a buyer, for purchasing an item from an online, multi-tiered business community. The buyer reviews a listing of an item for sale by a first provider. The buyer then provides payment for the item to a second provider on a higher tier within the business community and receives the item from the first provider.

### BRIEF DESCRIPTION OF THE DRAWINGS

These and other objects of the invention will be readily the following detailed description of the invention described in conjunction with the accompanying drawings, of which:

FIG. 1A is a block diagram depicting an exemplary community branch in accordance with one embodiment of the invention;

FIG. 1B is a block diagram depicting an exemplary online, multi-tiered business community in accordance with one embodiment of the present invention;

FIG. 2 is a flow chart illustrating the exemplary process by which individual businesses and organizations can register, create general listings and grow their respective communities via transactional content aggregation and syndication;

FIGS. 3A and 3B are a flow chart illustrating an exemplary process by which an individual business' content is posted and accepted by the ReAL business process in accordance with one embodiment of the invention;

FIGS. 4A and 4B are a flow chart illustrating an exemplary process by which the community and its individual businesses conduct business transactions, where the founder holds payment and directly receives commission-based revenue in accordance with one embodiment of the invention;

FIGS. 5A and 5B are a flow chart illustrating an exemplary process by which the community and its individual businesses conduct business transactions, where the child, parent, or superparent holds payment and the founder receives commission-based revenue after the child, parent, or superparent distributes the payment;

FIG. 6 is a block diagram illustrating a central controller in accordance with one embodiment of the invention; and

FIG. 7 is an illustration of a web page illustrating an example of a member profile form in accordance with an embodiment of the invention.

### DETAILED DESCRIPTION OF THE INVENTION

Various embodiments of the present invention disclose a self-aggregating, multi-tiered, online, business community which will allow smaller, specialty businesses to effectively establish themselves and compete in the Internet arena while preserving diversity in the marketplace and contributing to the growth of an online business economy. The online community, in certain embodiments, includes a multi-tiered commerce extranet for any community of businesses, including trade associations, non-profit and for-profit community building ventures, that may share a common set of goals and values.

One feature of the present invention is that such a community offers the opportunity to place large and small businesses in close proximity, which in turn allows for a cross-pollination of ideas,- information, and shared experiences that are invaluable in expanding the presence of the community of businesses.

Another feature is that the multi-tiered business community of the present invention offers individual businesses the opportunity to be established on the Internet and to effectively compete in today's industry while being part of a bigger community. This is accomplished by allowing individual member businesses to choose which tier in the business community they wish to join, where membership at each successive tier grants the individual business members increasing rights and business opportunities. Higher tiers may be attained through payment of higher fees. Thus, another feature of the multi-tiered business community of the present invention is that it offers members the opportunity to grow and expand at a natural rate.

Another feature of the present invention is that the multi-tiered business community's social, economic, and cultural interdependency allows different member businesses to attract a specific demographic of clients interested in certain experiences, services or products. Thus, the multi-tiered business community of the present invention, in certain embodiments, allows a visitor of the business community to be directed within the community to community members with products and services corresponding to the visitor's interest.

Another feature of certain embodiments of the present invention is that it enables members of the community, as well as online visitors, to select not-for-profit and/or charitable organizations to which a percentage of sales may be donated, thereby establishing a sense of trust and accountability that encourages visitors/users to return back to the community for future transactions.

Another feature of certain embodiments of the present invention is to provide revenue-generating opportunities to a founder site occupying a highest tier of the community via the issuance of technology product licenses to businesses for membership in each lower tier and from transaction-based commissions on sales by member businesses completed at the founder site.

Another feature of certain embodiments of the present invention is the opportunity that the businesses at certain levels within the multi-tiered community enjoy profit sharing in the revenue of an individual member company's sale of goods and/or services.

The present invention is, therefore, one solution to the removal and replacement of diverse shopping experiences with mass marketing and franchises as described above. Small, specialty-based businesses may depart from the current model of establishing an individual online presence which commands a high initial investment and instead opt for a community which allows for a more affordable approach while allowing for 1) maintenance of an individual presence and 2) the further growth of its own community via aggregation of content and advancement within the community based on business growth.

The online community employs a business model involving “The Community,” where “The Community” is a cluster of individual businesses that may join together based on their common values, beliefs and interests to form an online business association which encourages ongoing membership and advancement.

The online community may further provide a consumer-to-business and/or business-to-business transaction environment wherein online communities collect and manage pertinent information about each individual user who visits the online community, and social, economic, and cultural interdependencies are analyzed so that individual users can promptly engage in a community with products and services targeted precisely to their interest. Such a community may establish a sense of trust and accountability for individual users to return back to the community and may provide the community members with a profit incentive based on a share in the sale of an individual company's goods or services, where this share would depend on the specific tier in the community hierarchy to which they belong and the site at which a sale was completed.

The present invention relates to a method and system for building an online multi-tiered business community where participating websites aggregate and individually list their content onto a choice of different tiered sites accessible through a central portal (e.g. a single uniform resource locator (URL) address) and assembled by a single-entry, multi-site (SEMS) software editing package. More specifically, the present invention relates to methods and systems for registration and content posting by participating businesses onto the different tiered sites of the business community, for providing user access and membership in the community websites, for explaining the business transaction between consumers and businesses on the community, and for a revenue profiting process for the founder site and the different-tiered sites within the community.

### The Multi-Tiered Online Business Community

A suite of software software packages for implementing the community in one embodiment is referred to as Community Works™, a software application for building a multi-tier business and web technology infrastructure. It is, of course, to be understood that while in the embodiment described below, the Community Works™ software application is used to build a business community in which “ReAL.org” is the nominal founder site, the Community Works™ software application can be used to build a community for any type of business community with any founding organization.

The founder site for the multi-tiered online business community, which may be designated herein as “ReAL.org,” develops a virtual commerce application for the Internet where each prospective member places one or more “listings” for products and/or services on a network site for review and purchase. This multi-tiered infrastructure is governed by the founder site, ReAL.org, which occupies a highest tier in the business community. There are subsequent levels of the community hierarchy including, in descending order: a second tier, also referred to herein as a superparent or a member of a Community Works™ tier; a third tier, also referred to herein as a parent site or a member of a Village Square™ tier; fourth through sixth tiers which are collectively referred to as child sites, which can be referred to as any one of following three levels, in descending order: a Listing™ tier, a Storefront™ tier, or a Market Place™ tier.

The founder site may select and invite the superparents, or Community Work™ members, to join the community based on a set of prerequisites that identifies them as National Community Leaders™. The superparent in turn is in charge of selecting the parent and the children based on-a set of prerequisites geared towards the common goals and interests of the community. Each set of tiers below the founder is designated herein as a separate “community branch.”

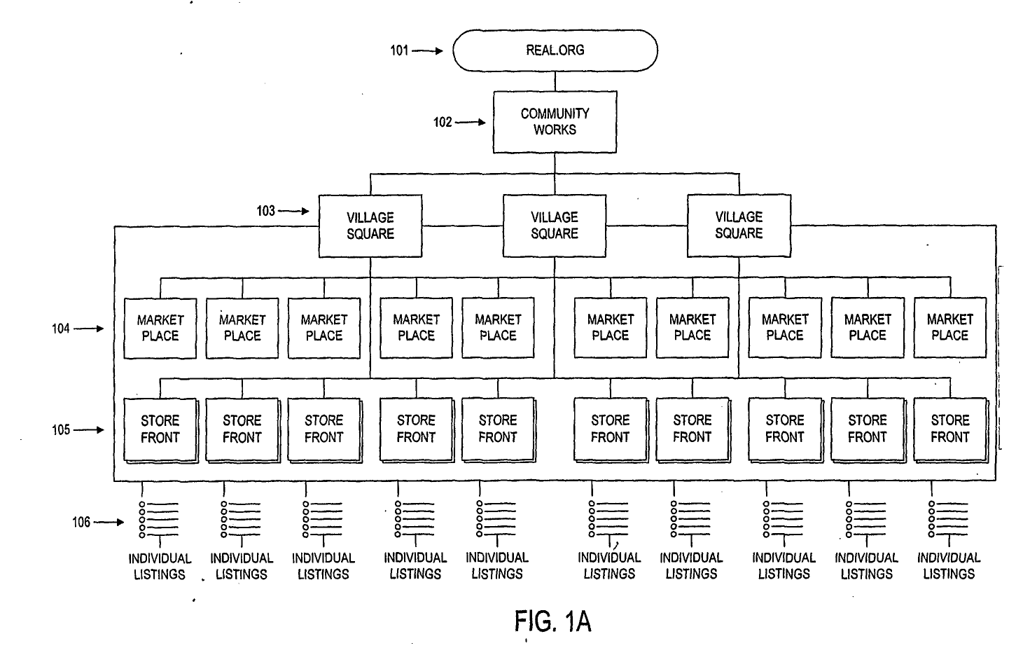

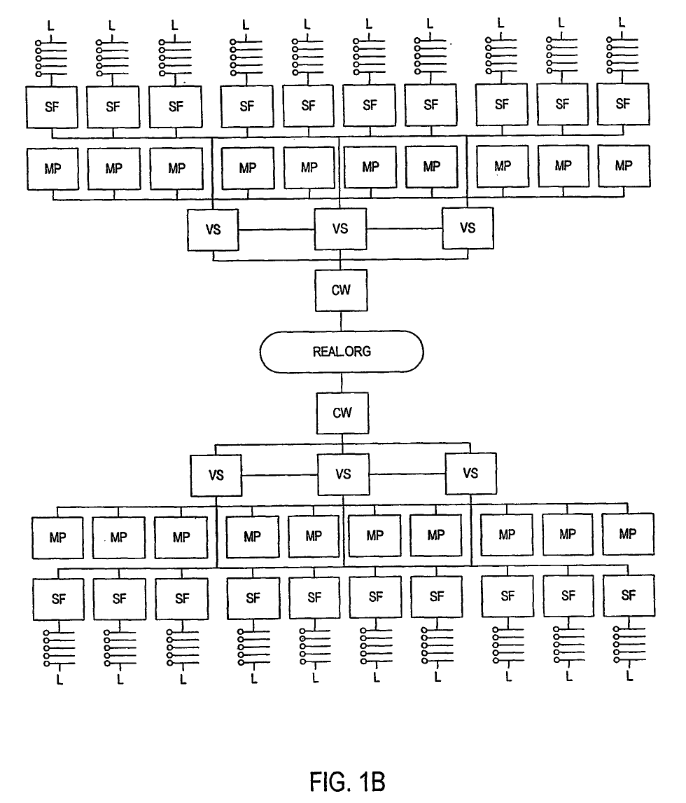

Certain embodiments of the present invention will now be described with reference to the accompanying drawings, in which like elements are referred to with common reference numerals. FIG. 1A is a schematic diagram illustrating an exemplary community branch of an online business community in relation to the highest tier. The participating members in the community branch may aggregate and/or individually list their content onto a choice of different tiered sites, ranging from the children sites (104, 105, 106, the parent sites 103, the superparent sites 102 to the founder site 101, through a SEMS software editor available in existing technologies.

In one embodiment, the founder site 101 develops and provides a suite of online tools (referred to herein as a toolbox) which are provided to lower tier community members in order to launch individual sites within the community branch. One such software tool, referred to herein as a COMMUNITY WORKS software package, may be offered by the founder to a superparent establishing a community branch in order to provide a multi-tier infrastructure for the community branch, including the superparent site, one or more parents, and one or more child sites. The superparent may be any member in a COMMUNITY WORKS tier 102. The parent may be any member in VILLAGE SQUARE tier 103. The child can be a member in a LISTING tier 104, a member in a STOREFRONT tier 105 or a member in a MARKETPLACE tier 106.

The COMMUNITY WORKS software package may be one of many such software tools, referred to herein as a ReAL Business Solution™ product, which can be used to build commerce extranets for any community of businesses, including trade associations, non-profit and for-profit community ventures. The license to utilize the COMMUNITY WORKS software package may include a unique re-seller agreement that allows superparents to grow their community branch exponentially. The SEMS technology included in the ReAL BUSINESS SOLUTION product fisher enables the superparent to aggregate commissionable content (for example, products, services, events) and community membership, thereby building a leadership position within their respective community branches and consequently expanding their presence on the Internet.

SEMS is a sophisticated transactional content aggregation system that allows community business members to syndicate and aggregate at the click of a mouse. Individual brand integrity is maintained while product exposure is dramatically increased. This is possible because members are able to create transactional content listings through the use of simple turn-key forms. A member can, with one click, simultaneously publish these listings to multiple websites within the community for promotion. Listings appear as full multi-media additions, and participating sites receive a commission for resulting sales at those respective sites.

The COMMUNITY WORKS product is a market-entry offering that is capable of aggregating limitless sub-members and including numerous transactional content listings within a community branch, in accordance with FIG. 1A.

As mentioned previously, the founder site may select and invite a target business for the COMMUNITY WORKS tier 102 based on predetermined criteria required by the founder site. More specifically, the selection process for the target business may revolve around the similarity in cultural beliefs, interests and values of the business community to be established. This selection process allows the founder site and members of selected other tiers (superparent and parent) within the community to act as “curators” who govern the admission and activities of businesses at lower tiers within the community branch by selecting only those businesses whose contents, products and services are consistent with the goals and interests of the community.

In a first embodiment of a “Selection Process,” referred to herein as a “Recruiting Selection Process,” the founder site creates a criteria list, researching possible superparents (for example, through market research analyst, consumer surveys, public surveys, annual reviews of the company, and the like) and comparing potential superparents' missions, goals, interests, beliefs, as well as product and/or service offerings which are consistent with the founder's. The founder may then decide, based on objective and subjective analysis, if the company would be an appropriate selection for the superparent tier. The founder will notify the prospective superparent of its offer to accept them into the community and the prospective superparent can accept or decline such offer.

In another embodiment of the Selection Process, referred to herein as the “Screening Selection Process,” a company which desires to be the superparent of a community branch may contact the founder and provide various information, market research, consumer surveys, annual reports and reviews, and the like to the founder. The superparent may also provide a proposal explaining why they would be an asset to the business community. Upon review of the provided documents and other outside research done by the founder, the founder may choose to accept or decline the prospective superparent's proposal to be part of the community.

To enter at the COMMUNITY WORKS tier 102 requires a purchase of a technology product license from the founder. The cost of this license may be a flat fee (i.e., $100,000). This is the most expensive level of the entire tiered system because it affords a member the greatest rights and business opportunities aside from the founder site.

The businesses at the COMMUNITY WORKS tier 102 may further include a select group of businesses, also referred to herein as NATURAL COMMUNITY LEADERS, a target group that includes members that may has been overlooked for leadership positions because they tend to be small, or who represent associations, non-profits and niche businesses which have a natural following of purveyors. In one embodiment, the purveyors may be providers of products and services. In particular, the purveyors may be providers of specialized professional services, such as holistic healthcare, lawyers, mediators, socially responsible stockbrokers, and the like.

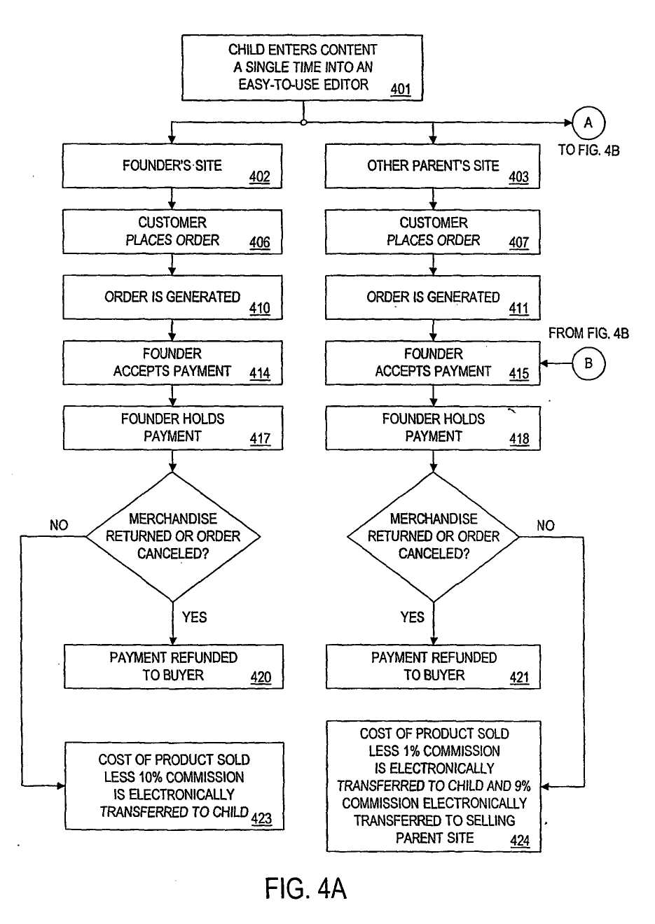

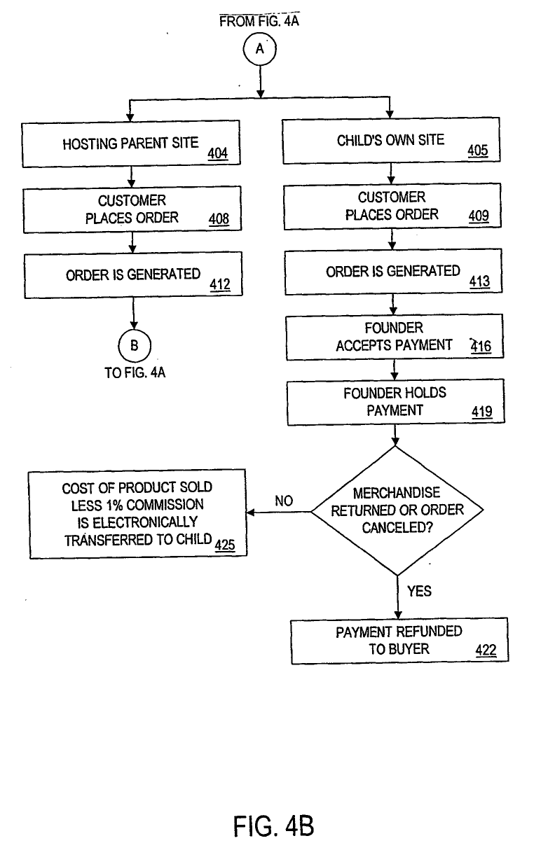

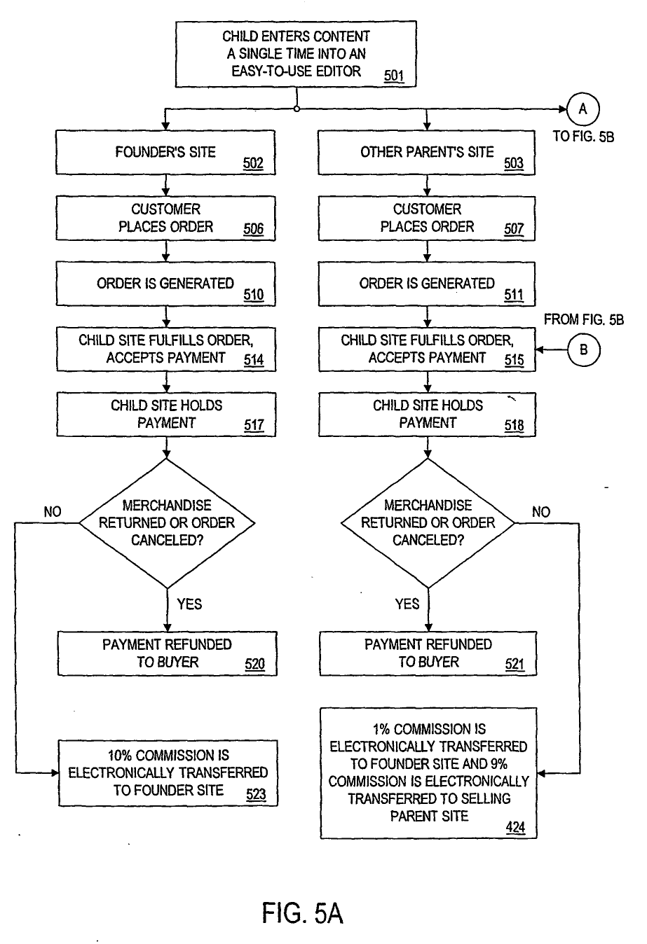

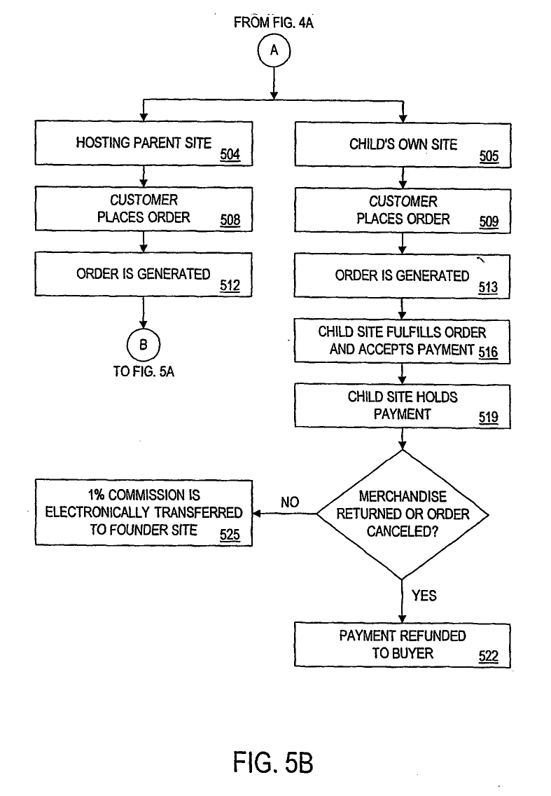

NATURAL COMMUNITY LEADERS are responsible for administration of another ReAL.org software tool, referred to herein as HIGHLY EFFECTIVE CURATORIAL SYSTEMS. ReAL.org visitors benefit from the discernment of Natural Community Leaders who, by definition, act as curators to select and recruit only the best available businesses having the most credible content, products, and services. Information may be further curated by psychographics and demographics. In addition, as shown in FIGS. 4 and 5, the superparent derives commission-based revenue from sales by businesses which belong to lower tiers (parent, child) under the particular superparent tier 102. Further, the superparent may derive revenue from a percentage of the technology product license (e.g., 20%, with the remainder of the license fee going to the founder site) taken by businesses which join the community at a lower tier (parent, child) under the umbrella of the superparent.

The second level of the multi-tiered business community within the community branch infrastructure includes one or more parents, occupying the VILLAGE SQUARE tier 103. At this tier 103, the members work closely with the founder site and the superparent to provide products and services to visitors. The superparent at the COMMUNITY WORKS tier 102 recruits and accepts parent and child businesses as members within the community branch through a selection process that focuses on the psychographics and demographics of each potential member. As discussed above, the Selection Process evaluates the natural forum for symbiotic relationships among participants in the community and may be restricted to a group of organizations that share a common set of goals and values.

Each member in the VILLAGE SQUARE tier 103 first provides a web presence for itself using a VILLAGE SQUARE software product, which consists of a suite of tools that furnish fundamental Internet capabilities for that organization. Integrated into the VILLAGE SQUARE toolbox are additional platforms that can be offered for sale to other companies, organizations, or individuals that would benefit from occupying a lower tier within the community branch. The member at this level, as at the COMMUNITY WORKS level, can invite (aggregate) other businesses (providers). In an additional embodiment, parents can customize catalogs and indices at the VILLAGE SQUARE level.

Therefore in one embodiment, the creation, development and expansion of VILLAGE SQUARE software products allows for aggregation and sharing of content of each lower-tiered site through a set of rule-based applications. More specifically, all of the sharing of information at this level is governed by a set of rules requiring permission by child, parent and superparent sites to grant, and parent and superparent sites to accept, such content. This is achieved through a distributed platform that allows each participant to share content and to associate only with other members it selects.

In another embodiment, the expansion to the COMMUNITY WORKS product will occur via the aggregation of participants once the VILLAGE SQUARE tier 103 is established. The aggregation of participants and content will grow according to the group's natural initiatives. Once individual community branches join the COMMUNITY WORKS multi-tiered infrastructure, NATURAL COMMUNITY LEADERS are able to provide another ReAL.org tool, a Network Marketing Aggregation product (also referred to herein as the SKY'S TEE LIMIT UPGRADE PATH), whereby each community member in the community branch is provided with the ability to sign on other businesses to the community.

Under the Network Marketing Aggregation system, at the VILLAGE SQUARE tier 103, members may bring in partners and providers. At the COMMUNITY WORKS tier 102, members can have their partners help them grow. Additionally, at the COMMUNITY WORKS level 102, members may become a profit-sharing partner with the founder site. In certain embodiments, profit sharing would be offered to NATURAL COMMUNITY LEADERS who achieve a predetermined level of participation in the business community (based on, for example, sales, commissions, number of businesses recruited, and the like). Members who wish to purchase the software tools to establish a VILLAGE SQUARE tier site in the community must, in one embodiment, pay a fee. For example, the cost might be a one time fee of $50,000.

As mentioned previously, the lowest tiers of the community branch are the MARKETPLACE tier 104, the STOREFRONT tier 105 and the LISTINGS tier 106, previously referred to as child sites. The child sites must, in one embodiment, enter a selection process of being recruited and accepted into the community via the COMMUNITY WORKS administration, and may be charged a smaller fee, depending on the desired tier they wish to enter. Each lower tier, in addition to incurring a lower fee, has a lower range of privileges and opportunities within the business community.

At the MARKETPLACE tier 104, a business may be able to have its own domain, homepage and/or brand. The domain may further be an online address that is related to that of the central portal. The businesses at this tier may add editorial, archives and advertising, as well as syndicate to higher levels in the community hierarchy and to other listings within the marketplace. A member at the MARKETPLACE tier 104, as at the higher COMMUNITY WORKS 102 and VILLAGE SQUARE tier 103, can also customize catalogs and indices and set up e-mail accounts for visitors. The cost, in one embodiment, may be a fixed cost of $10,000. Membership at this level can be purchased from any of the higher levels (VILLAGE SQUARE, COMMUNITY WORKS and founder) within the community.

At the STOREFRONT tier 105, a business member is able to set up its store front as a homepage on any of the founder, superparent or parent websites. However, its product listings are limited to a maximum number (i.e., 50, 75, etc.). The member's cost for setting up a STOREFRONT site is more economical (i.e., $1000) and can be obtained from the founder, a VILLAGE SQUARE member or COMMUNITY WORKS member within the community branch At the LISTINGS tier 106, a business can create a commerce listing for only one product line with associated sublines or descriptions relating to that one product line. Membership at the LISTINGS tier 106 can be obtained from the founder site or from a business at the VILLAGE SQUARE tier 103 or COMMUNITY WORKS tier 102. A business at the LISTINGS tier 106 can further syndicate to the sponsoring VILLAGE SQUARE, the founder, or other VILLAGE SQUARES and COMMUNITY WORKS members. It is envisioned that membership at the LISTINGS level will provide member businesses (especially new upstart companies) an affordable listing where the member's products or services can be exposed to the public market at nominal cost, for example, $50.

FIG. 1B shows an embodiment of a system in accordance with the present invention in which a plurality of community branches have been formed, each having multiple parent and children sites situated therein. It has been estimated that two hundred COMMUNITY WORKS sites could result in over one million product or service listings within the business community. As shown in FIG. 1B, the founder site, ReAL.org, includes within its expansive community a multitude of superparent sites (designated CW for COMMUNITY WORKS), parent sites (designated VS for VILLAGE SQUARE), and children sites (designated MP for MARKETPLACE, SF for STOREFRONT, and L for LISTINGS) to generate such listings.

### Registration of an Individual Business with the Multi-Tiered Online Business Community

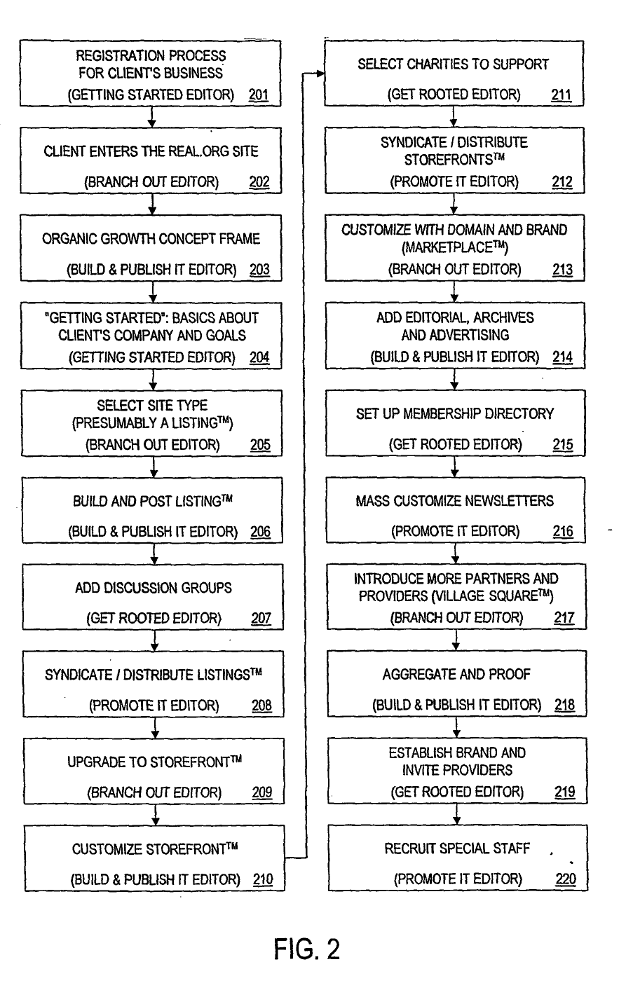

FIG. 2 is a flow chart illustrating an exemplary process 200 by which individual businesses and organizations can register, create general listings and grow their respective communities via transactional content aggregation and syndication. The first step is performing an exemplary registration process 201, by which the individual company or business that is first recruited by a NATURAL COMMUNITY LEADER during the internal Selection Process (where the client is screened or recruited) are allowed to register with the founder to become members of the community. In the registration step 201, the NATURAL COMMUNITY LEADER may provide registration forms to the potential member. The potential member may then complete the forms. The NATURAL COMMUNITY LEADERS then process the forms and the potential member receives notice that such forms are processed and accepted, after which the potential member selects their username and password to participate in the community Website. All potential members must first be registered with the founder, superparent and/or parent before they can enter the community to create their online marketing and services.

Once registration with the founder, superparent or parent site (founder, COMMUNITY WORKS or VILLAGE SQUARE, respectively) is complete, the newly-registered member may create a designated page on the sponsoring site (for example, the founder site in FIG. 2) and will be prompted to enter either a user name or password (step 202).

Next, at step 203, a control interface (referred to herein as the ORGANIC GROWTH CONCEPT FRAME) will be provided to the member. The ORGANIC GROWTH CONCEPT FRAME may contain many unique functions required to successfully grow within the community. This interface may provide members with each visitor's activities within the community through multi-media indicators. Multiple accounts are managed via user names and passwords. Using this tool, members may grow and expand at a natural pace. ReAL's ORGANIC GROWTH CONCEPT FRAME is thus provided to turn the expensive, confusing process of building a community into an easy and affordable experience for the community members.

In one embodiment, the ORGANIC GROWTH CONCEPT FRAME contains programming for accomplishing 18 functions performed in conjunction with steps 204-221 of process 200, described in detail below). The functions may be accomplished through five software editing applications, as follows:

(1) The “Getting Started” editor contains Function No. 1, in which the member begins setting up its site and selected goods and services to be offered therein (step 204). To accomplish this, the Getting Started editor may present basic questions about the member's company and goals, and then utilize the answers presented.

(2) The “Branch Out” editor contains Functions 2, 6, 10; 14 and 18 (corresponding to steps 205, 209, 213 217 and 221, respectively), where the member decides which tier to initially occupy or expand to within the community. At each function, the user is prompted to answer inquiries which assists them in setting up within the desired tier. With function 2 (step 205), the member may select entry into the LISTING tier 106. With function 6 (step 209), the member can upgrade to or enter the STOREFRONT tier 105. With function 10 (step 213), the member can upgrade to or enter the MARKETPLACE tier 104, at which they will be allowed to customize their own domain and brand. With function 14 (step 217), the member can upgrade to or enter the VILLAGE SQUARE tier 103, at which stage they will be allowed to sponsor other partners and/or providers into the community. With function 18 (step 221), the member may upgrade to or enter the COMMUNITY WORKS tier 102, at which stage they can let recruited businesses help them grow and become a profit-sharing partner with the founder and the remaining superparents.

(3) The “Build & Publish It” editor contains functions 3, 7, 11 and 15 (corresponding to steps 206, 210, 214, and 218, respectively) which enable a member to create a listing of products and services, events or articles. With function 3 (step 206), the member can build and post simple listings at the LISTINGS tier 106. For example, the LISTING may be automatically posted to the member's site and may further be automatically transmitted to the ReAL.org site for approval. With function 7 (step 210), the member can customize its website at the STOREFRONT tier 105. With function 11 (step 214), the member can add editorial content, archives and advertising at the MARKETPLACE tier 104. With function 15 (step 218), the member may review, accept and aggregate lower-tiered members' content within the community branch at the VILLAGE SQUARE tier 103.

(4) The “Get Rooted” editor contains functions 4, 8, 12 and 16 (corresponding to steps 207, 211, 215, and 219, respectively), where the member can find causes to support, resources to share, and other members within the community with which to collaborate. With function 4 (step 207), the member can add discussion groups at the LISTING tier 106. With function 8 (step 211), the member can select one or more charities they would like to support at the STOREFRONT tier 105. With function 12 (step 215), the member can create a membership directory at the MARKETPLACE tier 104. With function 16 (step 219), the member can establish its brand and invite providers at the VILLAGE SQUARE tier 103.

(5) The “Promote It” editor contains functions 5, 9, 13, and 17 (corresponding to steps 208, 212, 216, and 220, respectively), where the member can implement an integrated distribution campaign within the community. With function 5 (step 208), a member at the LISTINGS tier 106 can syndicate and distribute product and service listings to higher-tiered members for publication on their sites. With function 9 (step 212), the member at the STOREFRONT tier 105 can syndicate and distribute portions of its storefront to other higher-tiered sites. With function 13 (step 216), a member at the VILLAGE SQUARE tier 104 can send mass customized newsletters. With function 17 (step 220), a member can recruit special staff through its COMMUNITY WORKS site 103.

In the present embodiment, it is contemplated that a user accessing the “Branch Out” editor and utilizing one of functions 2, 6, 10, 14 or 18 to create a desired site for its business, will subsequently be able to access all lowered number functions as well as all higher numbered functions up to the function where the next highest tier is involved. For example, if a user utilizes function 10 to set up a site at the MARKETPLACE tier 104, the user can then access functions 1-9 and 11-13.

In a preferred embodiment, a member entering the community accesses the editors in the following order: “Getting Started,” “Branch Out,” “Build & Publish It,” “Get Rooted,” and “Promote It,” and proceeds from function 1 to the higher numbered functions in ascending numerical order (i.e., 1, 2, 3, etc.) depending on the initial tier they select using the “Branch Out” editor. Thus, for example, a member utilizing the ORGANIC GROWTH CONCEPT FRAME might proceed as follows:

1. Access the “Getting Started” editor and utilize the “Getting Started” function;

2. Access the “Branch Out” editor and use function 2 to activate and purchase a site at the LISTINGS tier 106.

3. Access “Build and Publish it” editor to use function 3 to build and post transactional content listings that may appear on the founder and/or sponsoring parent sites (assuming these sites approve the listing).

4. Access the “Getting Rooted” editor to use function 4 to add discussion groups related to the transactional content listing created with function 3 above.

5. Access the “Promote It” editor to use function 5 to syndicate listing(s) to other participating sites.

6. Access the “Branch Out” editor and use function 6 to activate and purchase a site at the STOREFRONT tier 105 which will act as a business page that will accommodate a greater number of product and service listings.

7. Access “Build and Publish it” editor to use function 7 to customize the site at the STOREFRONT tier 105 which has been purchased in function 6 above.

At all levels of this network marketing phase, where the individual business community registers and creates a listing for their products, services, or events onto the community, all activity of the child site may be reviewed and governed by the founder, superparent and/or parent.

### Content Screening and Posting Process

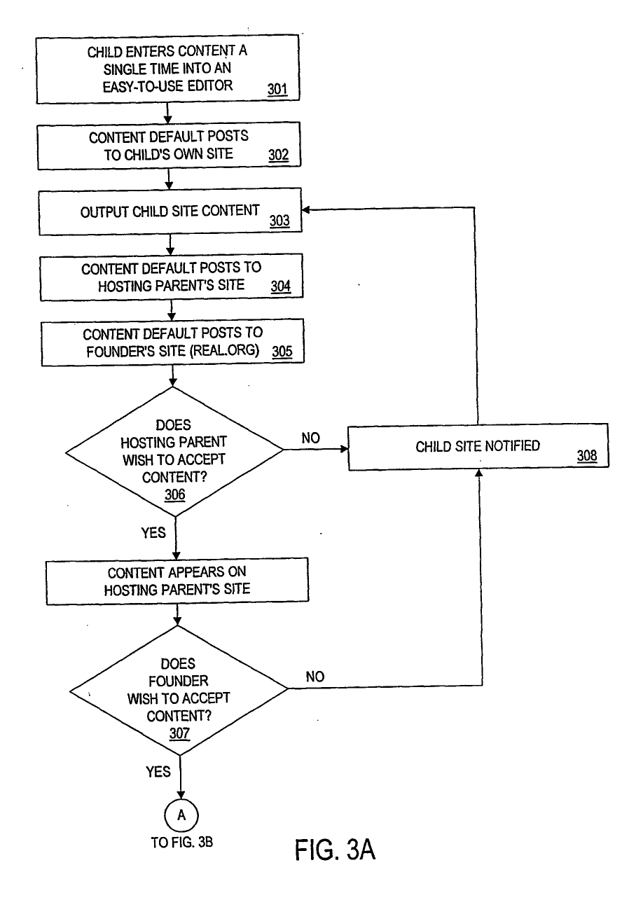

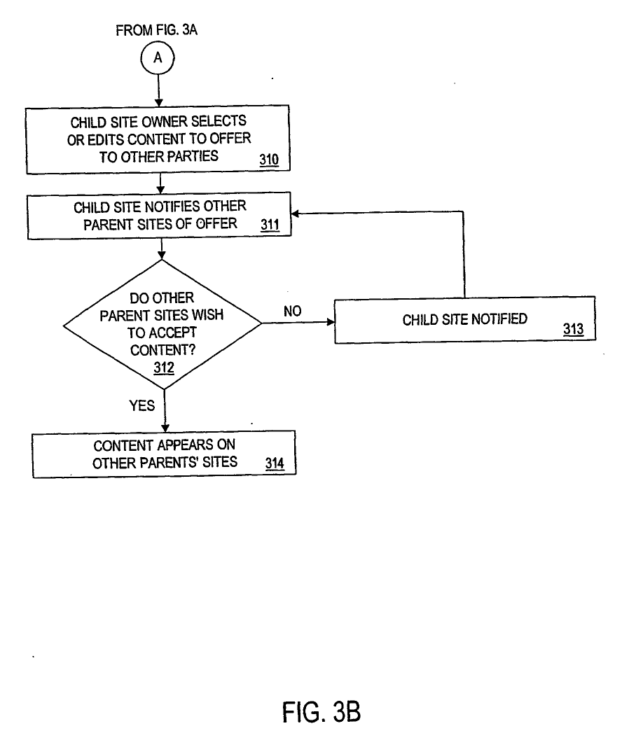

FIGS. 3A and 3B shows a flow chart illustrating an exemplary process 300 by which a member's content is posted and accepted by the community. All information entered by the child and parent site may be screened and posted by the remaining parents in the community branch, the superparent and/or the founder. Once the individual business enters the community, all or any of the content it conveys may be automatically presented onto the founder site and/or any other hosting site. This information can be shared with other parent sites or superparent sites if the individual business user grants permission to a parent or superparent site and the receiver site accepts the contents.

FIGS. 3A and 3B only show one child to founder and parent screening and posting for the simplicity of explaining the screening and posting process 300. However, it should be noted that the invention is capable of multiple parent-sibling site syndications or multiple domain/branding using SEMS.

An example of this process 300 begins when the child enters content a single time into the editor (step 301). This information instantly defaults and posts to the child's site (step 302). The information, known as the child content, is then default posted to the founder's site (step 305) and the hosting parent's site (step 304) for approval. The founder reviews the content (step 307) sent by the child. If the founder wishes to accept the content, the content will appear on the founder's site. Otherwise the child site is notified that the content has been rejected (step 309). Simultaneously, the hosting parent's site reviews the content (step 306) sent by the child. If the hosting parent wishes to accept the content, the content will appear on the Hosting Parent's site. If however, the content is rejected, the child site is notified (step 308).

Upon notification of rejection, the child has at least two options: to edit the content and offer the edited content to either the same parent sites or different parent sites, or to leave the content as is and offer it to another parent site (step 310). If the child site selects or edits content to offer to another parent site superparent site) the content is sent to the preferred site when the child notifies the other sites of the offer of content (step 311). The other parents (or superparents) may decide if they wish to accept the content (step 312). If the other parents (or superparents) decide to accept the child's content, the content appears on the parent's site. If the other parents (or superparents) reject the child's content, the child is notified (step 313).

In a further aspect of the invention, a multi-tier tracking feature, also known as ReALLivelihood™, members may utilize or create a virtual team of managers and online sales personnel. Members are thus virtually supported by a suite of real-time tracking tools that monitor activities and tally commissions for prompt pay. ReALLivelihood™ tracking further provides live sales and visitor activity reports and issue commission reports for prompt payment to hosting sites.

### Online Visitor Access

In one embodiment, online visitors (which may be visitors/users) enter the community, search the website and order products or services. The visitor benefits from a quantity of choices in a community that may easily contain one million potential listings. Additionally, online visitors may benefit by accepting a default donation to a charity which has been selected by the provider of the product or service they are purchasing. This program, called For The Giving™, trades donations and provides donating online visitors with data about the use of their funds via follow up e-mails.

In another embodiment, in addition to the discount incentive and the donation incentive for online visitors to return, the community offers a bonus incentive whereby visitors receive bonus points for the total of all moneys spent in purchasing online services and products, which can be used toward future purchases or business transactions (like instant credit or frequent flyer miles). This incentive program is known as “ReAL Credit.” In certain embodiments, visitors may even donate the instant credit or bonus points to their favorite charity, social or environmental organization, but may not ask for a cash equivalent of the bonus points be made payable to them. If the bonus points are not used for a set period, for example, 2 years, they may be cancelled.

### Demographic Profiling of Online Users

Upon entry of the online visitor into the community via the central portal, the online visitor is asked if they would like to proceed and fill out a profile (where all information that the online visitors provide will remain confidential) or whether the online visitor would like to by-pass the entire process. If the online visitor chooses to by-pass the entry of a profile they will be able to proceed with the business transaction as described above.

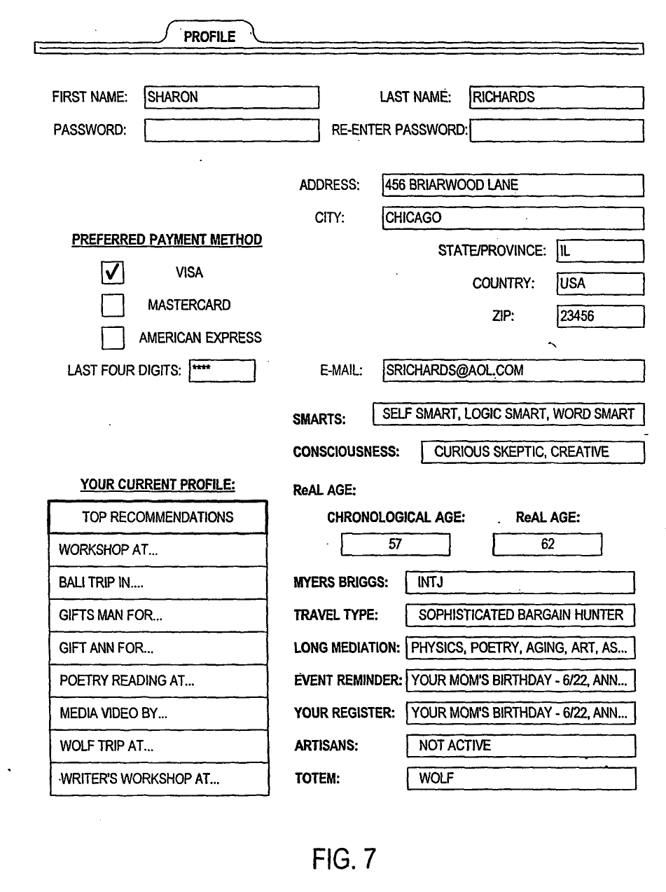

If the online visitor chooses to fill out the profile, however, they will answer inquiries on various topics that may be helpful to community members. This profile is designed to help the business community target a demographic of visitors/consumers interested in their products. For example, the community site may feature a series of interactive quizzes based on best-selling books and theories. In addition to answering the quizzes, the online visitors will provide their basic personal information including their complete name, password, address, and e-mail address (all of which remains confidential). FIG. 7 displays a sample profile filled out by an online user. Once the community receives and analyzes this information, the online visitor will be notified and may create profiles based on results for each area questioned. The community will then customize a personal newsletter which contains product information and services which caters to the online visitor. Once all the information is imputed, the user will receive, for example, recommendations of events, products and services geared to their personal profile. The recommendations may further include workshops, vacation sites, gifts for family and friends, events, and the like. This entire process of mass customization and profiling is known as “Your ReALity Magazine™.” The Your REALity Magaazine™ mass customizes personal profiles for the visitors by managing the user information and indexing certain topic areas most similar to the visitor's profile, thereby providing the individual visitor with a wide selection of products, services and events based on the visitor's preferences.

Once the online visitor has filled out a profile, they are free to search the community and are immediately able to receive the mandatory discounts extended only to visitors completing the profile process. The online visitor will be able to use and benefit from the membership. For example, a visitor completing the profile information may receive specific technological tools, such as the Life Positioning System™, which is a private and interactive guide that automatically delivers highly customized opportunities for unique, authentic and hard-to-find products, events and services that have personal, motivational and potentially life-changing meaning.

In a preferred embodiment, the community is adapted to attract the many individual users and participants of websites who are identified as Cultural Creatives, namely, persons who are attuned to global issues. This group is presently at 44 million individuals in the United States consumer market and is estimated to grow to 100 million by 2005. Cultural Creatives may be disenchanted with the idea of “owning more stuff,” but they put a strong emphasis on having new and unique experiences. On the deepest level, they are powerfully attuned to global issues. Cultural Creatives are found in all regions of the country. They are altruistic and often less concerned with success or making a lot of money, although most live comfortably with middle to upper-middle incomes. They are far more likely than not to have graduated from college. Their median age (42 years) is close to the national average for adults, but they tend to cluster around their mid-age point with relatively few elderly and young adults. More than half of Cultural Creatives are women.

Despite their numbers, Cultural Creatives may be underserved and have not been identified by traditional marketing methods. Cultural Creatives tend to believe that few people share their values. This is partly because their views are rarely represented in the mainstream media. Cultural Creatives are likely to be information junkies. They follow the news and read a great deal, although they watch a lot less TV than the average American. They are more influenced by editorials than advertising. Paradoxically, little of what they read gives them any evidence of their huge numbers.

Cognitive style is a key to understanding the Cultural Creatives. While they take in a lot of information from a variety of sources, they are good at synthesizing it into a “big picture.” It is believed that by placing COMMUNITY WORKS and VILLAGE SQUARE software packages in several appropriate organizations, this underserved yet affluent group will galvanize around this newly available set of resources, fostering the sale and use of an expanding network of virtual communities.

Customers have become increasingly aware and demanding of company's social and environmental policies. This is especially true of the Cultural Creative demographic where a Cultural Creative customer is five times more likely to purchase a product they know comes from a company with strong environmental and social policies.

Thus, by offering a profile function to members of the business community, the present embodiment offers businesses who have invested a great deal of revenue and research in their environmental and social policies the opportunity to capitalize on their investment by targeting products or services directly at a demographic that are concerned with these issues. Reaching this channel could take months, if not years, for a business and require a huge investment in marketing and advertising. By being part of the community of the present invention, they are instantly immersed in the cultural creative demographic.

### Revenue Opportunities for Members

According to another aspect of the invention, the many business transactions in the community gives rise to an Incremental Revenue Opportunity Process whereby the founder site generates revenue directly from COMMUNITY WORKS technology licenses and transaction-based commissions, and different members, such as THE NATURAL COMMUNITY LEADERS, are provided with new revenue opportunities from increased sales, branded technology re-sale, and commissions from aggregated transaction content.

In one embodiment, the founder site receives revenue from the following sources: 1) fees received from Internet Product Licensing for the LISTING, STOREFRONT, MARKETPLACE, VILLAGE SQUARE, and COMMUNITY WORKS, particularly, the purchase of any software toolbox and licensing of those tools; 2) fees received from customization of those products including creative development, production, programming and other back end services; 3) commission from any purchase of products or service sold from any listings (child, parent, superparent, or founder cite) by an online visitor (i.e., commissions, for example, may range from 1-10%); and 4) revenue from sale of advertising space content syndication.

In another embodiment, the superparent receives revenue from the following sources: 1) increased sales of their product on the online community; 2) branded technology resale and licensing (Technology Product Development), and 3) commission from aggregated transactional content of the online community.

FIGS. 4A and 4B show a flow chart illustrating an exemplary process 400 by which the community and its individual businesses conduct business transactions, where the founder holds payment and directly receives commission-based revenue.

In one embodiment the child enters content a single time into a SEMS editor (step 401). The child site content appears on multiple domains including the founder site (step 402), another parent's site (or superparent site) (step 403), hosting parent's site (or hosting superparent's site) (step 404) and the child's own site (step 405). On any or on each of these respective sites, the customer may place an order (steps 406-409). Thereafter, the order is generated on the respective sites (steps 410-413). In order for the business transaction to be completed for the consumer, the founder must accept payment and the child site must fulfill the order (steps 414-416). The founder may hold payment from the customer for 30 days (steps 417-419). If the merchandise is returned or cancelled, the payment is refunded to the buyer (steps 420-422). If the merchandise is not returned or cancelled then the distribution of the revenue on the founder's site (step 423) is the cost of the product sold less, for example, 10% commission for the founder site. The balance may then be electronically transferred to the child.

For a sale on the other parent's site (or superparent site) or the hosting parent's site (or hosting superparent's site), if the merchandise is not returned or cancelled then the distribution of the revenue on the these sites (step 424) may be the cost of the product sold less 1% commission for the founder and 9% commission for the selling parent or superparent site (which electronically transferred to the selling parent or super parent site). The balance may then be electronically transferred to the child.

On the child's own site, if the merchandise is not returned or cancelled then the distribution of the revenue from the sale (step 425) may be the cost of the product sold less 1% commission for the founder site, with the balance electronically transferred to the child.

FIGS. 5A and 5B are a flow diagram illustrating an exemplary process 500 by which the community and its individual businesses conduct business transactions, where the child, parent, or superparent holds payment and the founder receives commissions based revenue after the child, parent, or superparent distributes the payment. In one embodiment, the child enters content a single time into an easy to use editor (step 501). The, child site content appears on multiple domains including the Founder Site (step 502), other parent's site (or other superparent sites) (step 503), hosting parent's site (or hosting superparent's site) (step 504) and the child's own site (step 505). On any or on each respective site, the customer places an order (steps 506-509). Thereafter, the order is generated on the respective sites (steps 510-513).

In order for the business transaction to be completed for the consumer, the child site must fulfill the order and accept payment while the founder or other respective parent or superparent sites are notified of the order (steps 514-516). Child holds payment from the customer for 30 days (steps 517-519). If the merchandise is returned or cancelled, the payment is refunded to the buyer (steps 520-522). If the merchandise is not returned or cancelled, then the distribution of the revenue for the child on the founder's site (step 523) may be the cost of the product sold less 10% commission for the founder site, whereby the founder's commission is electronically transferred. On the other parent's site (or other superparent sites) and hosting parent's site (or hosting superparent's site), if the merchandise is not returned or cancelled then the distribution of the revenue on the these sites (step 524) may be the cost of the product sold less 1% commission for the founder, and 9% commission for the selling parent or super parent site (both of these commissions may be electronically transferred to the selling parent or superparent site and the founder).

On the child's own site, if the merchandise is not returned or cancelled then the distribution of the revenue on the child's own site (step 525) may be the cost of the product sold less 1% commission for the founder, which is electronically transferred to the founder. In steps 523-525, the child may be holding payment and may be directly paid.

### Marketing Advantage for Donations

Another marketing advantage for a business within the community is the opportunity-for members to select not-for-profit companies to which a percentage of sales is donated. There are numerous ways that the charities, social and environmental groups may be selected/screened by the community.

In one embodiment, businesses that have not yet implemented aggressive social or environmental policies can start in this direction by choosing relevant organizations to donate funds. This may help to position them more competitively with the cultural creative community, described above. They will have the advantage of promoting these donations on their site as well as on other sites within the community. Each time a donation is made, the customer will receive an e-mail thanking them and telling them where a percentage of their money has gone. This is an inexpensive and effective way to add social and environmental concerns to a brand.

In another embodiment of the invention known as the “Three Way Transaction” feature, also referred to as For the Giving™, both non-profit companies and visitors are provided with a turnkey option that authorizes an automatic donation to a specified charity each time a transaction is made. Consumers are provided with real-time tallies and reports. Non-profit companies may additionally broadcast messages about activity and needs to supporters. This non-profit grassroots effort is a way to leverage relationships with commercial partners to automatically funnel a percentage of the projected $20 billion dollars toward needed projects and resources. For the Giving™ allows vendors to choose the charities they want to support (including small, local charities) and provides the consumers with real-time accounting of how funds are being used. The community thus establishes a sense of trust and accountability that encourages continued participation.

In yet another embodiment of the invention, only the founder and the members at the COMMUNITY WORKS tier 102 choose the charities and/or social and environmental issues through a selection process to be displayed on each site on which the consumer enter, whereby the consumer can choose which organization donations are to be sent.

In another embodiment, the child, parent, superparent, and founder are all involved in selection of the charities and/or social and environmental organizations through a selection process and all the selected charities are to be displayed on their site for visitors to choose from.

In still another embodiment, the consumer has the freedom to choose from all the charities available within the entire community to decide where their funds should be donated. The founder may be the only one who may screen charities based on the culture of the community.

For example, in one embodiment called ReAL Charity™ (which is part of the Three Way Transaction feature, where the online visitor can apportion the percentage of their payment for services to their favorite charity, social or environmental group), every time the online visitor makes a business transaction they will be asked to which charity money is to be sent. In another embodiment of REAL CHARITY, every time the visitor makes a business transaction the money is directly sent to the charity, social or environmental organizations they initially choose when they submitted a profile. Visitors are free to change the settings of this feature at anytime they want.

### Central Controller Operated by the Sites

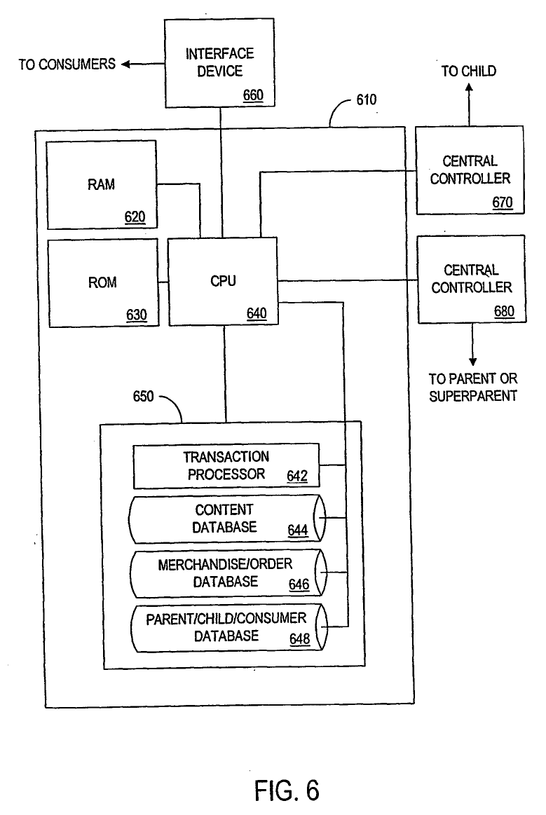

FIG. 6 illustrates an embodiment of the central controller 610 for a system according to the present invention. As shown in FIG. 6, central controller 610 includes central processing unit (CPU) 640, random access memory (RAM) 620, read-only memory (ROM) 630, large capacity storage device 650 (such as a hard drive), and effectuates interaction with further central controllers 670 and 680, transaction controller 642 and consumer interface device 660. CPU 640, preferably is a conventional microprocessor such as an INTEL PENTIUM processor, and is electronically coupled to each of the central controller 610's other elements.

CPU 640 executes program code stored in one or more of RAM 620, ROM 630 and storage device 650 to carry out the functions and acts described in connection with central controller 610. CPU 640 preferably comprises at least one high-speed digital data processor adequate to execute the program modules for, for example, registering a member's business, posting content to sites, effectuating communication among the founder, parents (or superparents), child and consumers, effectuating consumer transactions, and the like. The module for executing such methods are described in connection with FIGS. 1A-5. CPU 640 interacts with RAM 620, ROM 630 and storage device 650 to execute stored program code according to conventional data processing techniques.

Central controllers 670 and 680 relate to the controllers of the child, and parent (or superparent), respectively and may operate in the same manner as the founder central controller 610 described herein. Furthermore, any number of central controllers may communicate cooperatively to form the online community.

Transaction processor 642 maintains, determines and accesses data stored in the databases. Transaction processor 642 may comprise a separate, conventional CPU/microprocessor, or a portion of the operating function of CPU 640. Content database 644 stores information associated with the content produced by the founder, superparent, parent and/or children.

Consumer interface device 660 comprises any device which may allow a consumer to interact with one or more of the central controllers 670, 680 of the system. Such communication is accomplished electronically by means of the Internet and may include a conventional high speed modem employing known communication protocols capable of decrypting/encrypting data received from a remote consumer terminal.

Large capacity storage device 650 contains processing instructions sufficient for operating the CPU 640 and the transaction processor 642. Large capacity storage device 650 may also store one or more databases, such as content database 644, merchandise/order database 646, and parent/child/consumer database 648 illustrated in FIG. 6. Product and transaction information is stored in merchandise/order database 646, whereas information relating to the consumers, superparent, parent, and children (including licensing fee information) are stored in parent/child/consumer database 648. Although central controller 610 is described with respect to the founder's site, FIG. 6 illustrates an exemplary, embodiment of the central controllers used at other sites such as those of the superparents, parents, children, and the like. Furthermore, it should be understood that one or more functions described herein as being performed through the use of a central controller 610 may also be performed in any other manner. For example, transmission of data between two parties as described herein may be conducted offline through the use of telephone communication, facsimile transmission, in-person conversation, via mail or parcel delivery, and the like.

### EXAMPLE 1

An Example of a Natural Growth Path Using REAL Tools

A Natural Foods Cooperative has a network of suppliers and shoppers as well as common goals and relationships with other natural food stores and restaurants. With long term plans that include a network of these stores, Natural Foods Cooperative first establishes its Internet presence using Village Square software. It can immediately begin filling the site with content that promotes its products and services to visitors. It can also begin offering STOREFRONT technology to a number of businesses, such as natural food distributors, natural food suppliers, as well as local farms and dairies. Natural Foods Cooperativee will be able to select which of these STOREFRONTs have their content aggregated on Natural Food Cooperative's own site. Similarly, the STOREFRONT owners are free to select which other members of the growing STOREFRONT community it wishes to interact with. STOREFRONTs may begin to include other, tangential services and products that would tend to be associated with that group. Examples might be health clubs, traditional and alternative medicine, sportswear, certain publications (such as fitness and wellness magazines), and individuals who provide related services.

Using COMMUNITY WORKS, the entire VILLAGE SQUARE may be networked with other groups within the community, providing additional content, more sales, and a national and international network of trusted services. The self-monitoring, curatorial role played by the founders and members of each community branch will eliminate the random noise that clutters most Web experiences. It will also provide a supporting community that monitors the products and services offered within the group, which encourages and even demands high standards in the products and services being offered within the group.

### EXAMPLE 2

Target Community Works Clients

The following examples illustrate how the founder site may benefit by leveraging the market reach and strong affinity of each respective hypothetical Community Works client.

| | | Estimated |
|---|---|---|
| PROSPECTIVE | | number of products |
| Community Works | Numbers of business | and services that can |
| CLIENT | community members | be aggregated to the |
| (Natural Community | that sell products and | REAL.org site through |
| Leaders) | services | the SEMS system |
| TV Talk Show | Talk show host inter- | Each interview may |
| | views an estimated 150 | reference 2 products or |
| | authors, producers and | services for and estim- |
| | purveyors of services and | ated total of 900. |
| | goods each year. (That's | |
| | 450 over three years.) | |
| Exotic Vacation | Approximately 30,000 | Each purveyors has an |
| Magazine | purveyors of unusual | estimated average of 3 |
| | trips and service. One | trips, for a total of |
| | potential sub-member, | 90,000 offerings. |
| | the Association of Exotic | |
| | Vacation Firms-has and | |
| | estimated 14,000 mem- | |
| | bers. | |
| Natural Foods | Approximately 500 nat- | Approximately 5,000 |
| Association | ural foods stores ranging | products and services |
| | from small shops to pub- | can be aggregated |
| | ically traded stores like | here. |
| | Natural Foods Inc. | |

What is claimed is:

1. A method for establishing an online, multi-tiered, business community, comprising:
implementing a first tier for allowing a first provider to post first content on a first network site accessible from a central portal; and
implementing a second tier, lower than the first tier, for allowing at least one second provider to post second content on a second network site accessible from the central portal, wherein the at least one second provider each forms a distinct community branch and both the at least one second provider and the second content are subject to approval by the first provider.

2. The method of claim 1, wherein the first tier may be populated by only one first provider.

3. The method of claim 1, wherein the second tier may be populated by a predetermined number of second providers.

4. The method of claim 1, further comprising:
implementing a third tier, lower than the second tier, for allowing at least one third provider to provide third content on a third network site accessible from the central portal, wherein both the at least one third provider and the third content are subject to approval from the first provider and the second provider from the same community branch.

5. The method of claim 4, wherein the third tier may be populated by a predetermined number of third providers.

6. The method of claim 4, further comprising:
implementing a plurality of subsequent tiers, lower than the third tier, for allowing at least one fourth provider to provide fourth content on a fourth network site accessible from the central portal, wherein both the at least one fourth provider and the fourth content are subject to approval from each of the first provider, the second provider and the at least one third providers in the same community branch.

7. The method of claim 6, wherein the plurality of subsequent tiers may each be populated by a predetermined number of fourth providers.

8. The method of claim 6, wherein the plurality of subsequent tiers comprise a market place tier for allowing the fourth provider to post the fourth content on at least one of said first, second, third and fourth network sites.

9. The method of claim 6, wherein the plurality of subsequent tiers comprise a store front tier for allowing the fourth provider to post the fourth content on at least one of said first, second and third network sites, wherein the fourth content is limited to a predetermined number of item listings.

10. The method of claim 6, wherein the plurality of subsequent tiers comprise a listing tier for allowing the fourth provider to post the fourth content on at least one of said first, second and third network sites, wherein the fourth content is limited to one item listing.

11. A method, performed by a first provider, for establishing an online, multi-tiered, business community, comprising:
establishing the first provider in a first tier for posting first content on a first network site accessible from a central portal; and
establishing a second provider in a second tier, lower than the first tier, for posting second content on at least a second network site accessible from the central portal, wherein the second provider is invited to participate by the first provider and the second content is subject to approval by the first provider.

12. The method of claim 11, wherein at least a portion of the second content is available on the first network site.

13. The method of claim 11, wherein the first tier is populated by only one first provider.

14. The method of claim 11, wherein the second tier is populated by a plurality of second providers, each of the plurality of second providers forming a distinct community branch.

15. The method of claim 11, further comprising:
receiving a fee from the second provider for said establishing in the second tier.

16. The method of claim 11, wherein the second content comprises a listing of an item for sale by the second provider.

17. The method of claim 16, further comprising:
establishing a commission to be retained by the first provider from a sale of the item by the second provider on the first network site.

18. The method of claim 17, wherein the commission comprises a percentage of a financial amount of the sale.

19. The method of claim 16, further comprising:
receiving an indication of a sale of the item from the second provider to a buyer at the first network site,
receiving a financial amount from the buyer; and
providing a portion of the financial amount to the second provider, the portion based on a commission to be provided to the first provider.

20. The method of claim 16, further comprising:
receiving an indication of a sale of the item from the second provider to a buyer at the first network site; and
receiving a portion of the financial amount from the second provider, the portion based on a commission to be provided to the first provider.

21. The method of claim 11, further comprising:
establishing a third provider in a third tier, lower than the second tier, for posting third content on at least one of the first and second network sites and a third network site accessible from the central portal, wherein the third provider is invited by the second provider to participate in the community branch and the third content is subject to approval from both the first provider and the second provider.

22. The method of claim 21, further comprising:
receiving a fee from the third provider for said establishing in the third tier.

23. The method of claim 21, wherein the third content comprises a listing of an item for sale by the third provider.

24. The method of claim 23, further comprising:
establishing a commission to be retained by one of the first provider and the second provider from a sale of the item by the third provider at the respective first and second network sites.

25. The method of claim 24, wherein the commission comprises a percentage of a financial amount of the sale.

26. The method of claim 23, further comprising:
receiving an indication of a sale of the item from the third provider to a buyer at the first network site;
receiving a financial amount from the buyer; and
providing a portion of the financial amount to the third provider, the portion based on a commission to be provided to the first provider.

27. The method of claim 23, further comprising:
receiving an indication of a sale of the item from the third provider to a buyer at the second network site; and
receiving a portion of the financial amount from the third provider, the portion based on a commission to be provided to the second provider.

28. The method of claim 23, father comprising:
receiving an indication of a sale of the item from the third provider to a buyer at the third network site.

29. The method of claim 21, further comprising:
implementing a fourth provider in a subsequent tier, lower than the third tier, for posting fourth content on at least one of the first, second and third network sites and a fourth network site accessible from the central portal, wherein both the fourth provider and the fourth content are subject to approval from the first provider, the second provider and the at least one third providers in the same community branch.

30. The method of claim 29, wherein the subsequent tier comprises a market place tier for allowing the fourth provider to post the fourth content on at least one of said first, second, third and fourth network sites.

31. The method of claim 29, wherein the subsequent tier comprises a store front tier for allowing the fourth provider to post the fourth content on at least one of said first, second and third network sites, wherein the fourth content is limited to a predetermined number of item listings.

32. The method of claim 29, wherein the plurality of subsequent tiers comprise a listing tier for allowing the fourth provider to post the fourth content on at least one of said first, second and third network sites, wherein the fourth content is limited to one item listing.

33. The method of claim 29, further comprising:
receiving a fee from the fourth provider for said establishing in the subsequent tier.

34. The method of claim 29, wherein the fourth content comprises a listing of an item for sale by the fourth provider.

35. The method of claim 29, further comprising:
establishing a commission to be retained by one of: the first provider and the second provider from a sale of the item by the fourth provider at the respective first and second network sites.

36. The method of claim 35, wherein the commission comprises a percentage of a financial amount of the sale.

37. The method of claim 29, further comprising:
receiving an indication of a sale of the item from the fourth provider to a buyer at the first network site;
receiving a financial amount from the buyer; and
providing a portion of the financial amount to the fourth provider, the portion based on a commission to be provided to the first provider.

38. The method of claim 29, further comprising:
receiving an indication of a sale of the item from the fourth provider to a buyer at the second network site; and
receiving a portion of the financial amount from the fourth provider, the portion based on a commission to be provided to the first provider.

39. The method of claim 29, further comprising:
receiving an indication of a sale of the item from the fourth provider to a buyer at the third network site; and
receiving a portion of the financial amount from the fourth provider, the portion based on a commission to be provided to the third provider.

40. The method of claim 11, further comprising:
completing a sale of an item to a buyer, and
providing a portion of a financial amount received from the sale to a charity designated by the buyer.

41. A computer readable medium encoded with processing instructions for implementing a method, performed by a computer, for establishing an online, multi-tiered business community, the method comprising:
establishing a first provider in a first tier for posting first content on a first network site accessible from a central portal; and
establishing a second provider in a second tier, lower than the first tier, for posting second content on a second network site accessible from the central portal, wherein the second provider is invited to participate by the first provider and the second content is subject to approval by the first provider.

42. An apparatus for establishing an online, multi-tiered business community, comprising:
means for establishing a first provider in a first tier for posting first content on a first network site accessible from a central portal; and
means for establishing a second provider in a second tier, lower than the first tier, for posting second content on a second network site accessible from the central portal, wherein the second provider is invited to participate by the first provider and the second content is subject to approval by the first provider.

43. An apparatus for establishing an online, multi-tiered, business community, comprising:
a processor; and
a memory in communication with the processor, the memory for storing a plurality of processing instructions for directing the processor to:
establish a first provider in a first tier for posting first content on a first network site accessible from a central portal; and
establish a second provider in a second tier, lower than the first tier, for posting second content on a second network site accessible from the central portal, wherein the second provider is invited to participate by the first provider and the second content is subject to approval by the first provider.

44. A method for operating a multi-tiered, online, business community including a first provider providing first content in a founder tier from a first network site, the method comprising:
providing an invitation to a second provider to join a second tier, lower than the founder tier;
receiving an acceptance of the invitation from the second provider;
providing a second network site for the second provider; and
receiving an indication of second content to be posted on one of the first network site and the second network site, wherein the indication of second content is provided for approval.

45. The method of claim 44, further comprising:
providing an approval of the second content to the second provider.

46. The method of claim 44, wherein the second content corresponds to an item for sale by the second provider.

47. The method of claim 46, further comprising:
establishing a commission to be paid to the first provider for a sale of the item by the second provider to a buyer on the first network site.

48. The method of claim 47, wherein the commission is determined based on whether the sale was completed from the first network site or the second network site.

49. The method of claim 44, further comprising:
completing a sale of an item to a buyer; and
providing a portion of a financial amount received from the sale to a charity designated by the buyer.

50. A computer readable medium encoded with processing instructions for implementing a method for operating a multi-tiered, online, business community including a first provider providing first content in a founder tier from a first network site, the method comprising:
providing an invitation to a second provider to join a second tier, lower than the founder tier;
receiving an acceptance of the invitation from the second provider;
providing a second network site for the second provider; and
receiving an indication of second content to be posted on one of the first network site and the second network site, wherein the indication of second content is provided for approval.

51. An apparatus for operating a multi-tiered, online, business community including a first provider providing first content in a founder tier from a first network site, comprising:
means for providing an invitation to a second provider to join a second tier, lower than the founder tier;
means for receiving an acceptance of the invitation from the second provider;
means for providing a second network site for the second provider; and
means for receiving an indication of second content to be posted on one of the first network site and the second network site, wherein the indication of second content is provided for approval.

52. An apparatus for operating a multi-tiered, online, business community including a first provider providing first content in a founder tier from a first network site, comprising:
a processor; and
a memory in communication with the processor, the memory for storing a plurality of processing instructions for enabling the processor to:
provide an invitation to a second provider to join a second tier, lower than the founder tier;
receive an acceptance of the invitation from the second provider;
provide a second network site for the second provider; and
receive an indication of second content to be posted on one of the first network site and the second network site, wherein the indication of second content is provided for approval.

53. A method for operating a multi-tiered, online, business community including a first provider providing first content in a founder tier from a first network site, the method comprising:
receiving an invitation from the first provider to join a second tier, lower than the founder tier, the second tier comprising a community branch;
transmitting an acceptance of the invitation to the first provider;
receiving an assignment of a second network site from the first provider; and
transmitting an indication of second content to be posted on one of the first network site and the second network site, wherein the indication of second content is transmitted for approval by the first provider.

54. The method of claim 53, further comprising:
providing a payment of a fee to the first provider for said assignment.

55. The method of claim 53, further comprising:
receiving an approval of the second content from the first provider.

56. The method of claim 53, wherein the second content corresponds to an item for sale by the second provider.

57. The method of claim 56, further comprising:
providing a commission to the first provider for a sale of the item to a buyer on the first network site.

58. The method of claim 57, wherein the commission is determined based on a financial amount corresponding to the sale.

59. The method of claim 53, further comprising:
completing a sale of an item to a buyer; and
providing a portion of a financial amount received from the sale to a charity designated by the buyer.

60. The method of claim 53, further comprising:
transmitting an invitation to a third provider to post third content in a subsequent tier within the community branch.

61. The method of claim 60, further comprising:
receiving an acceptance of the invitation from the third provider.

62. The method of claim 61, further comprising:
transmitting an assignment of a third network site for allowing the third provider to post third content.

63. The method of claim 62, further comprising:
receiving a fee from the third provider for the assignment.

64. The method of claim 62, further comprising:
receiving third content from the third provider for posting on at least one of the first network site, the second network site and the third network site, the third content subject to approval by at least one of the first provider and the second provider.

65. The method of claim 64, further comprising:
transmitting approval of the third content to the third provider.

66. The method of claim 64, wherein the third content comprises a listing of an item for sale by the third provider.

67. The method of claim 66, further comprising:
establishing a commission to be paid to at least one of the first provider and the second provider for a sale of the item to a buyer by the third provider on the respective first and second network sites.

68. A computer readable medium encoded with processing instructions for implementing a method for operating a multi-tiered, online, business community including a first provider providing first content in a founder tier from a first network site, the method comprising:
receiving an invitation from the first provider to join a second tier, lower than the founder tier, the second tier comprising a community branch;
transmitting an acceptance of the invitation to the first provider;
receiving an assignment of a second network site from the first provider; and
transmitting an indication of second content to be posted on one of the first network site and the second network site, wherein the indication of second content is transmitted for approval by the first provider.

69. An apparatus for operating a multi-tiered, online, business community including a first provider providing first content in a founder tier from a first network site, comprising:
means for receiving an invitation from the first provider to join a second tier, lower than the founder tier, the second tier comprising a community branch;
means for transmitting an acceptance of the invitation to the first provider;
means for receiving an assignment of a second network site from the first provider; and
means for transmitting an indication of second content to be posted on one of the first network site and the second network site, wherein the indication of second content is transmitted for approval by the first provider.

70. An apparatus for operating a multi-tiered, online, business community including a first provider providing first content in a founder tier from a first network site, comprising:
a processor; and
a memory in communication with the processor, the memory for storing a plurality of processing instructions for directing the processor to:
receive an invitation from the first provider to join a second tier, lower than the founder tier, the second tier comprising a community branch;
transmit an acceptance of the invitation to the first provider;
receive an assignment of a second network site from the first provider; and
transmit an indication of second content to be posted on one of the first network site and the second network site, wherein the indication of second content is transmitted for approval by the first provider.

72. A method for operating a multi-tiered, online, business community including a first provider providing first content in a founder tier from a first network site and a second provider in a second tier, lower than the founder tier, providing second content from a second network site and the second tier forming a community branch, the method comprising:
receiving an invitation from the second provider to join a subsequent tier, lower than the second tier, within the community branch;
transmitting an acceptance of the invitation to the second provider;
receiving an assignment of a third network site from the second provider; and
transmitting an indication of third content to be posted on at least one of the first network site, the second network site and the third network site, wherein the indication of third content is transmitted for approval by at least one of the first provider and the second provider.

73. The method of claim 72, further comprising:
receiving an acceptance of the third content from at least one of the first provide and the second provider.

74. The method of claim 72, further comprising:
providing a payment of a fee to at least one of the first provider and the second provider for the assignment.

75. The method of claim 72, wherein the third content comprises a listing of an item for sale by the third provider.

76. The method of claim 75, further comprising:
paying a commission to at least one of the first provider and the second provider for a sale of the item to a buyer by the third provider on the respective first and second network sites.

77. The method of claim 75, further comprising:
completing a sale of the item to a buyer; and
providing a portion of the financial amount received for the sale to a charity designated by the buyer.

78. A method, performed by a buyer, for purchasing an item from an online, multi-tiered business community, comprising:
reviewing a listing of an item for sale by a first provider;
providing payment for the item to a second provider on a higher tier within the business community; and
receiving the item from the first provider.

79. The method of claim 78, further comprising:
providing demographic data to one of the first provider and the second provider.

80. The method of claim 78, further comprising:
designating a charity to receive a portion of the payment of the item.
